(19) United States
(12) Patent Application Publication
(10) Pub. No.: US 2009/0116338 A1
(43) Pub. Date: May 7, 2009

(54) Identifying a stress anomaly in a subsurface region

(76) Inventor: Henricus Louis Jozef Guido Hoetz, Assen (NL)

Correspondence Address: SHELL OIL COMPANY, P O BOX 2463, HOUSTON, TX, 772522463, US

(21) Appl. No.: 11/918,273

(22) PCT Filed: Apr. 13, 2006
(86) PCT No.: PCT/EP2006/061584

§ 371 Date: Oct. 11, 2007

(30) Foreign Application Priority Data
Apr. 15, 2005 (EP) 05103033.6

(51) Int. Cl. G01V 1/30

(52) U.S. Cl. 367/75

(57) ABSTRACT

A method for identifying a local stress anomaly in a subsurface region, which method comprises the steps of obtaining a model of the subsurface region, which model includes a salt layer in between adjacent layers; identifying a salt weld in the model; and attributing a stress anomaly to an area surrounding the salt weld.

### FIELD OF THE INVENTION

The present invention relates to a method for identifying a stress anomaly in a subsurface region.

### BACKGROUND OF THE INVENTION

A detailed understanding of properties in the subsurface, such as rock properties or reservoir properties, is key for the exploration and production of hydrocarbons such as oil and gas.

For example, knowledge about acoustic velocities in the subsurface has a direct influence on the quality of the results obtained from seismic surveys of the subsurface. A good understanding of seismic velocities is required, in order to allow the obtaining of accurate depth information from interpreting time-dependent seismic signals. Failing an accurate depth prognosis can cause poorly positioned wells or, in some cases, missing the hydrocarbon bearing interval altogether. Other important subsurface properties are porosities and permeabilities of the reservoir rock in hydrocarbon bearing levels.

Abovementioned subsurface properties are influenced by the stresses acting on the rocks and which give rise to diagenesis and/or compaction. By better understanding the stresses acting on the rocks, one can estimate more precisely the rock properties relevant for hydrocarbon accumulations.

In an article “Salt tectonics driven by differential sediment loading: stability analysis and finite-element experiments”, L. Gemmer et al., Basin Research (2004) 16, 199-218, the deformation of subsurface salt on geologic timescales is discussed, and the motion and velocity pattern on such timescales are modelled. The formation of. e.g. salt diapirs and salt welds is mentioned.

In SPE paper No. 84554 “Stress perturbations adjacent to salt bodies in the deepwater Gulf of Mexico” by J. T. Fredrich et al. the geomechanical interaction between salt bodies and surrounding formations is discussed at the hand of four types of geometries, a spherical salt body, a salt sheet (pancake geometry), a columnar salt diapir, and a columnar salt diapir with tongue. Thin horizontal-lying salt sheets, even if laterally extensive, are not predicted to cause significant stress perturbations, other than directly within the salt body, where the horizontal stress will equal the vertical stress. Substantial stress perturbations are only apparent for salt sheet thicknesses in excess of several thousand feet.

It is an object of the present invention to provide a new method for identifying a local stress anomaly in a subsurface region.

### SUMMARY OF THE INVENTION

To this end there is provided a method for identifying a local stress anomaly in a subsurface region, which method comprises the steps of

obtaining a model of the subsurface region, which model includes a salt layer in between adjacent layers;

identifying a salt weld in the model; and

attributing a stress anomaly to an area surrounding the salt weld.

The invention is based on the insight gained by Applicant that a salt weld gives rise to a stress anomaly in its surroundings.

The expression salt weld is used in the claims and in the description to refer to a region in the subsurface where a salt layer that is sandwiched between an upper and a lower adjacent layer is locally thinned such that the salt is effectively absent. At sufficiently high pressure and temperature salt can be plastically deformed by compressive forces exerted by adjacent hard rock layers. Salt can be squeezed out laterally, and concentrate in salt domes or diapirs. A salt weld is often identified on seismic data, and applies to those areas where the salt layer thickness has reduced to a distance less than the seismic resolution, typically in the order of 10 meters.

In the typical case, the overburden has a higher density than the underlying salt and hence gravitational segregation leads to movement. The overburden subsides in the deforming salt until a rigid obstacle is encountered. Such an obstacle can be a structural high on the topography on the layer below the salt layer (base salt topography), e.g. a horst block, which is a crustal block raised up with respect to neighbouring blocks by faulting.

The contact or near contact between overburden and underburden at a salt weld leads to a vertical stress concentration. The overburden transmits an increased proportion of its weight to the underburden via the salt weld. I.e., the vertical stress is increased compared to laterally surrounding areas, and for this reason the detection of a salt weld can be taken as an indication of a stress anomaly.

The increased vertical stress will be highest at the touch down point, and decrease further away. The stress (re)distribution in the surrounding of the salt weld can also be referred to as stress arching. A salt weld typically has a surface area of less than a few hundred m², such as less than 500 m², in particular less than 200 m², and can even be less than 100 m². So, a typical extension in all horizontal directions can for example be at most 50 m, and even as low as 10 m and less. Due to the point-loading of stress, concentrated on such a small area, the stress anomaly is typically significantly higher than any stress effects at the boundaries of a laterally extended salt body such as a salt sheet. The vertical stress in the overburden immediately above a salt weld can be 50% higher, in particular even 100% higher or more, compared to the case that no salt weld is present.

Suitably, the salt layer surrounding the salt weld has a thickness of at most 20 m, often even at most 10 m, within a distance up to 200 m from the salt weld, preferably up to 300 m, even up to 500 m from the salt weld. A characteristic geometry where this applies is an extensive sheetlike salt layer (typically larger than several km² surface area, such as more than 2 km², even more than 5 km²), of which the thickness for more than 90% of the surface area is less than 50 m.

Suitably the model is obtained by interpreting seismic data pertaining to the subsurface region. The method further suitably comprises obtaining a quantification of the stress anomaly, for example by geomechanic modelling, in particular by a finite elements method, of the subsurface region.

A qualitative application of the present method can give valuable insight already. Suitably the method further comprises estimating a property or parameter of the subsurface region, in particular a rock property or a reservoir property, or identifying an anomaly in such a property or parameter. In many cases the stress situation is an important mechanism controlling rock properties. Local stress anomalies will give rise to anomalous rockproperties. Recognizing and quantifying the local stress anomalies assists in predicting the relevant rock properties.

The vertical stress concentration around a salt weld has consequences for other properties in the subsurface. The stress concentration leads to more compaction, both above the salt weld and also below the weld. The seismic velocities are affected, which is important know for accurate time-depth conversion. In the particular case of a reservoir region underneath the salt weld, the increased stress typically causes a deterioration of the reservoir bearing rock from a hydrocarbon production point of view. In particular, poorer porosity and/or permeability can be observed.

As a further result of the present invention an updated model of the subsurface region can be obtained, by refined interpretation of the seismic date using the identified stress anomaly, in particular when changes in seismic velocity have been quantitatively estimated. The updated model can in particular be an updated geometrical model of the subsurface region.

### BRIEF DESCRIPTION OF THE DRAWINGS

An embodiment of the invention will now be described in more detail and with reference to the accompanying drawings, wherein

FIG. 1 shows schematically a simple model of a subsurface region before a salt weld is formed;

FIG. 2 shows schematically the subsurface region of FIG. 1 after formation of a salt weld;

FIG. 3 shows schematically the model of FIG. 3 with an indication of parameters used for calculation;

FIG. 4 shows schematically an indication of the stress arching effect in the overburden due to the salt weld; and

FIG. 5 shows a seismic representation of a subsurface area wherein a salt weld has been identified.

Where the same reference numerals are used in different Figures, they refer to the same or similar objects.

### DETAILED DESCRIPTION OF THE INVENTION

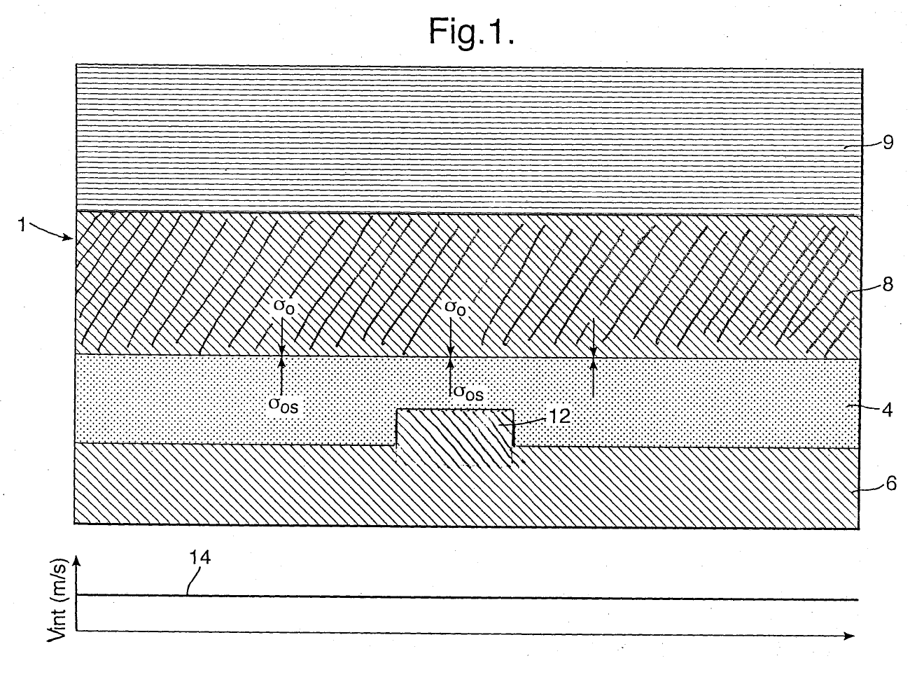

Reference is made to FIG. 1, showing schematically a typical situation in a subsurface region 1 prior to the formation of a salt weld. A salt (halite) dominated Zechstein layer 4 is sandwiched between Rotliegend 6, and Triassic shale/sand layers 8. The overburden 9 above Triassic is post Triassic.

In this initial situation the halite layer is sufficiently rigid to support the entire overburden uniformly. Vertical stress at a particular depth is substantially constant laterally across the region 1. This is indicated by the three pairs of stress arrows of equal sign and opposite direction σ₀ and σ₀ₛ, which will be discussed in more detail below. Hence seismic velocities, in particular the so-called seismic interval velocities Vᵢₙₜ (m/s), are equal throughout the Triassic layer 8, as shown schematically in curve 14. The topography of the pre-salt layers is not relevant for the stresses in the post-salt situation. I.e., the presence of the horst block 12 on top of Rotliegend 6 does not influence the stress in the overburden.

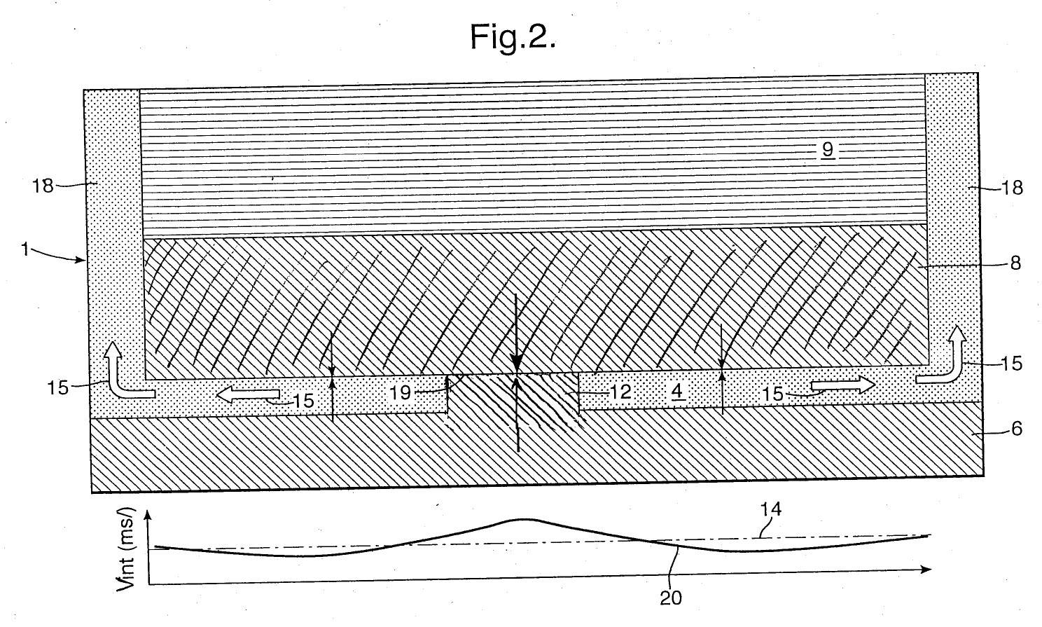

Reference is made to FIG. 2, showing schematically the situation in the region 1 after some time. Due to changing conditions, e.g. an increase in temperature and/or pressure, the halite layer rheology has changed from rigid to plastic, i.e. it behaves as a viscous fluid. Salt is relatively light compared to the overburden, and gravitational forces trigger movement. The salt tends to be squeezed out laterally as shown by the arrows 15 and concentrates in diapirs/domes as indicated at 18. As a result, the overburden subsides until an obstacle is encountered, such as in this case the horst block 12. The overburden weight will then be carried, preferentially, by the horstblock. The interface between the obstacle and the overburden, i.e. in this case between the Triassic layer 8 and the horst block 12, has developed into a salt weld 19.

Above and below the horstblock the vertical rock stress will be higher than in the laterally adjacent areas. Higher rock stress leads to higher seismic velocities, both directly and also via larger burial compaction (such as e.g. through the compaction of clay into clay stone). The dependence of seismic velocity near the lower boundary of the Triassic layer 8 as a function of the lateral distance is qualitatively shown in curve 20. The meaning of the stress arrow pairs will be discussed below.

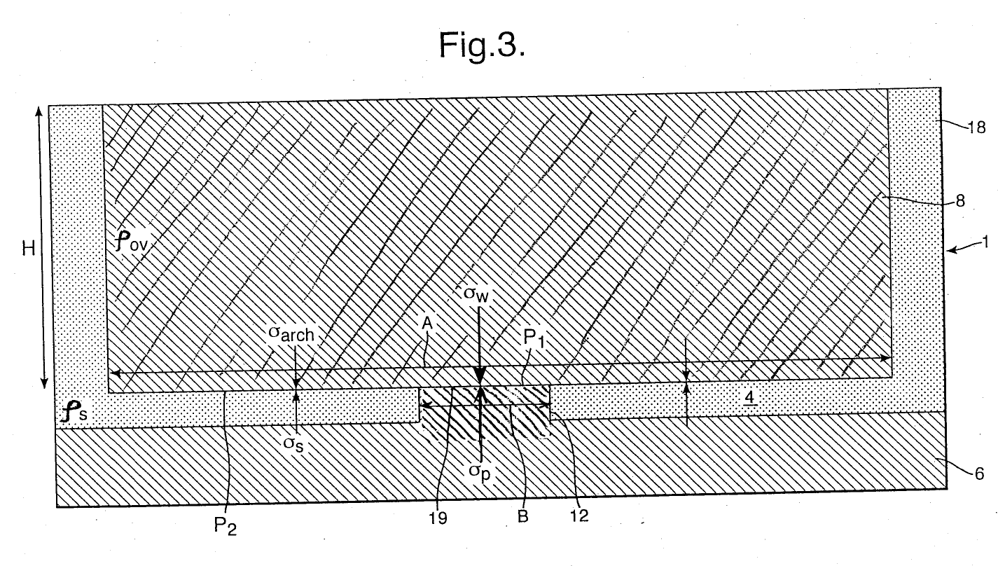

Reference is now made to FIG. 3, at the hand of which a simple geomechanical model for describing the stress anomaly caused by a salt weld in the subsurface region 1 will be discussed. For simplicity the post Triassic layer 9 is not shown. It is further assumed that the height H of the overburden equals the height of the salt dome 18.

At position P1 on top of the horst block or pillar 12, stress will increase as a result of the weight of the subsided overburden, and stress at position P2, on top of the halite layer 4, some distance laterally adjacent the horst block 12, will be diminished.

Estimates of the absolute and relative stress increase at P1 will now be derived at the hand of a simplified model, wherein it will be understood that not all aspects of salt-induced stress arching are fully represented. An overburden block of finite horizontal cross-section (A) will be considered.

The total force Fₒᵥ (N) exerted by the weight of the overburden block is given by:

Fₒᵥ=ρₒᵥAHg, (1)

wherein
ρₒᵥ: average density of overburden (kg/m³);
A: surface area of the total overburden block (m²);
H: height of overburden (m);
g: gravity constant (N/kg).

In the situation of FIG. 1, when the salt layer 4 is rigid and continuous, this weight is uniformly carried by the underlaying salt. The vertical stress σ₀ (N/m²) prior to salt flow is equal at every position on top of the salt layer 4, controlled by the weight of the overburden, according to the expression:

σ₀=ρₒᵥHg (2)

and is compensated by an upward force (equivalent to stress σ₀ₛ) from the salt layer, having equal sign and opposite direction of σ₀, cf. FIG. 1.

However, in the situation of FIGS. 2 and 3, when the salt layer has become plastic and squeezed out, the weight of the overburden is partly supported by the mobile salt, and partly by the horst block following:

Fₒᵥ=F_{block}+Fₛₐₗₜ, (3)

wherein
F_{block} and Fₛₐₗₜ are the upward forces (N) exerted by the horst block (salt weld), and by the salt layer outside the salt weld, respectively.

The upwardly directed force Fₛₐₗₜ is given by:

Fₛₐₗₜ=σₛ(A−B), with (4)

B: surface area of the salt weld (m²), and in which the isotropic stress σₛ in the salt layer is given by

σₛ=ρₛHg (5)

(Pascal principle), wherein
ρₛ: average density of salt (kg/m³).

Note, that in this model the salt is regarded as a continuous liquid phase to the surface, and can be seen as buoyant force. In the case B=0 this force follows directly from Archimedes' principle.

F_{block} can be estimated by combining equations (1), (3), and (4) to yield:

F_{block}=Hg(ρₒᵥA−ρₛA+ρₛB) (6)

The upward vertical stress at the interface 19 between overburden and horst block σₚ (N/m²) after salt flow (cf. FIGS. 2 and 3) is given by:

σₚ=F_{block}/B=Hg(ρₒᵥA/B−ρₛA/B+ρₛ), (7)

and has equal magnitude as the downward stress σ_{w} exerted by the overburden on the salt weld. Clearly, both have higher magnitude than the vertical stress the interface some distance away from the salt weld, σ_{arch} balanced by σₛ.

An absolute value of the stress anomaly σₐ as a result of the grounded overburden is obtained by:

σₐ=σₚ−σ₀=HgΔρ(A/B−1), (8)

wherein Δρ=ρₒᵥ−ρₛ.

An expression for the relative stress anomaly is given by:

σₐ/σ₀=(Δρ/ρₒᵥ)(A/B−1). (9)

From above follows that the stress increase is proportional with Δρ, and that the stress increases with the ratio of the overburdenblock surface area (A) vs. the salt weld surface area (B).

The stress anomaly is calculated here at the position of the boundary (interface) between the horst block and the overburden. In order to evaluate the stresses away from this area, geomechanical modelling for example by a finite element method can be used.

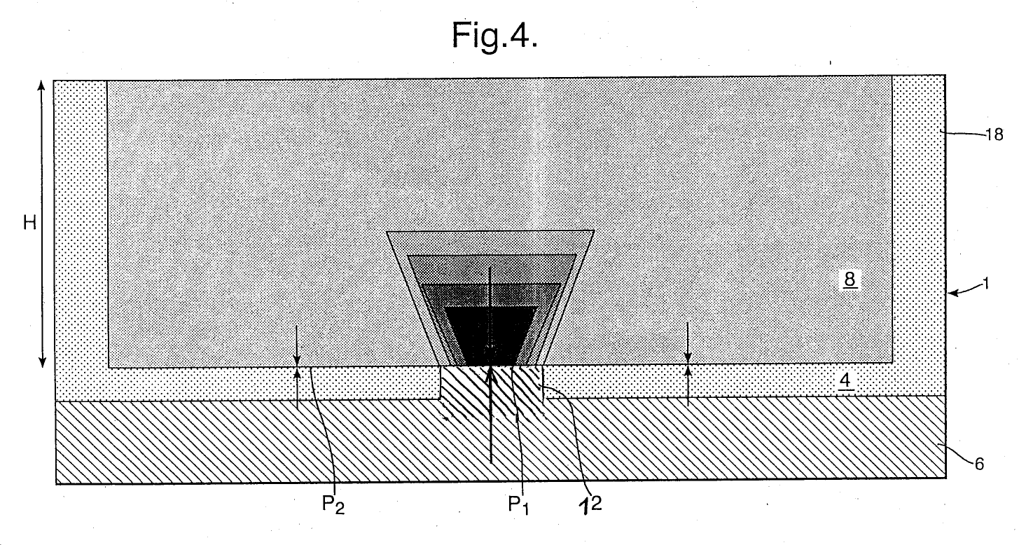

In FIG. 4 a schematic representation of the stress increase as a result of the stress anomaly is given; the darker the colour the larger the stress increase due to the formation of the salt weld. Generally in the overburden, the stress anomaly reduces horizontally and vertically away from the pillar top via stress arching principles. Similarly, the stress anomaly reduces in the substratum away from the bottom of the horst block (not shown).

In the simple model discussed above the salt rises all the way up to the surface. In practical cases, few saltdomes do actually pierce all the way to the surface. However, the analysis (except expression (9)) remains valid for non-piercing saltdomes (H is then the height of the saltdome), for as long as the salt phase is non-constrained (or pressured) by the overburden of the saltdome.

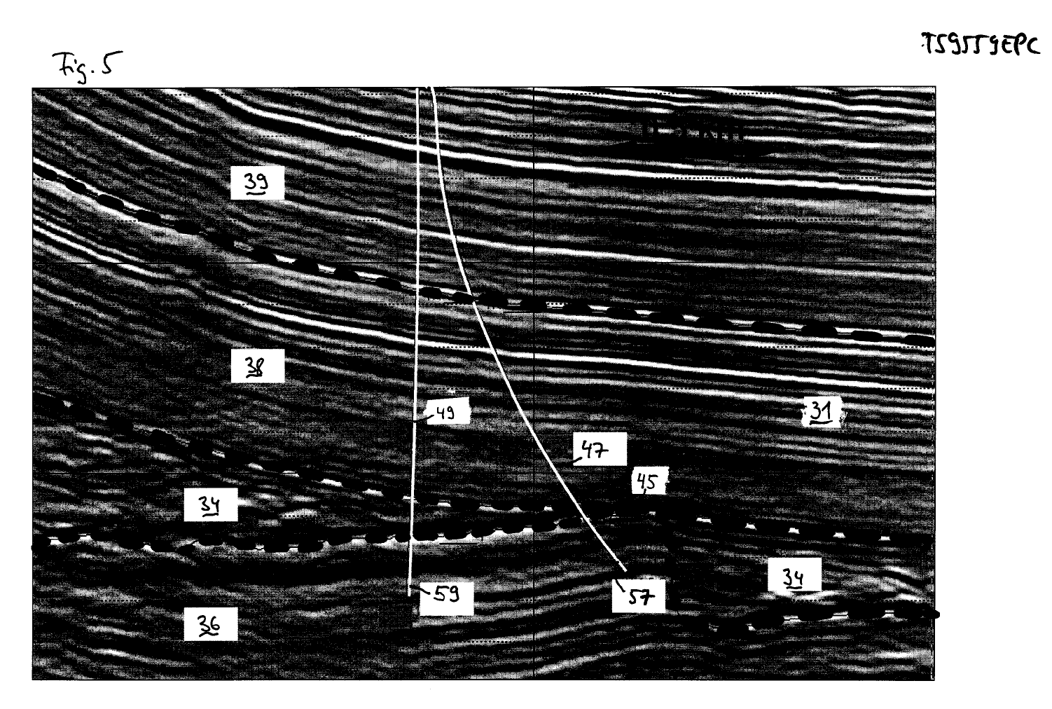

Reference is now made to FIG. 5. This Figure shows a seismic image which represents a vertical cut of approximately a 2 km depth interval through a region 31 in the subsurface. A halite layer 34 is present on top of Rotliegend 36 being reservoir rock). The Triassic and Post Triassic overburden 38 and 39 have subsided such that a salt weld 45 between Triassic and Rotliegend is formed. The boundaries between the layers are indicated by dashed lines. It will be understood that obtaining a model of the subsurface region including a salt layer can be done in the course of the interpretation of seismic data, and in the present case a salt weld has been identified.

Two wellbores 47 and 49 have been drilled through the subsurface region 31. Wellbore 47 penetrates through the halite layer 4 relatively close to the salt weld 45, where the thickness of the halite is less than 10 m, whereas wellbore 49 penetrates through the halite layer 4 further away from the salt weld 45, where the halite thickness is 150 m.

Seismic velocities have been determined in the Triassic layer via sonic logging. From the sonic log measurements average acoustic velocities for the Triassic layer have been derived. After backing out the effect of depth differences, a normalised interval velocity called V₀ has derived, all methodology that is well known in the art. As a result a V₀ of 3600 m/s was obtained for well 49, and a V₀ of 3876 m/s for well 47. So the velocity along wellbore 47 was found to be about 8% higher than the velocity along wellbore 49.

Also, it was found by density wireline logging that the porosity of the Rotliegend at the lower end 57 of wellbore 47 was poor (12%), compared to a significantly higher porosity of 14% at the lower end 59 of wellbore 49.

By using the method of the present invention, conclusions about seismic velocity and porosity could have been drawn before drilling the wellbores. The method allows to identifying a local stress anomaly, when the available information about the subsurface region is first combined in a model, for example from interpreting seismic data as in the representation of the subsurface in FIG. 5, wherein a salt layer in between adjacent layers is present, and wherein a salt weld is identified. According to the invention a stress anomaly is attributed to an area surrounding the salt weld. Therefore it is possible to qualitatively predict the increase in seismic velocity in the region above the salt weld, and the lowered porosity due to increased compaction underneath. Already from such a qualitative analysis, by using the method of the invention one could have concluded that it is not sensible to drill the wellbore 47 into area 57, because Rotliegend porosity will be poor, which is undesired for the production of hydrocarbons.

If in another case the reservoir rock below the salt layer was a carbonate rock, which typically has a low porosity, it could be expected that more fractures are formed in the carbonate rock underneath the salt weld. Since fractures in carbonate are desired for hydrocarbon flow, it can in this case be desired to drill to an area underneath the salt weld.

Suitably a quantification of the stress anomaly is obtained, e.g. using geomechanic modelling of the salt weld induced stress arching in the subsurface region, in particular by numerical modelling such as with a finite elements method. In this way for example the stress distribution around the salt weld can be modelled, and the changes in seismic velocity can be predicted. The influence of the salt weld on the stresses in all three dimensions can be evaluated, if desired all components of the stress tensor can be considered. If the modelling also involves reservoir modelling, conclusions about a property of the reservoir, such as porosity or permeability of the reservoir rock, or a fracture density, can be drawn and preferably quantitatively estimated. Key parameters relevant for the modelling are: dimensions, mass and rheology of the overburden rockpackage, surface area dimensions of the salt weld, height of the associated saltdome and density of the salt.

When the change in seismic velocities has been estimated, this data can be used for re-processing the seismic survey, so that an updated model of the subsurface region is obtained.

The present invention allows to improve depth predictions from seismic surveys when a salt weld can be identified. With the invention, salt induced stress arching can be identified, and the consequences can be taken into account, both in the modelling of the subsurface and in the planning of drilling operations. If the influence on acoustic (seismic) velocities was not taken into account, this can lead to wrong depth predictions of the target level and consequently missing the reservoir. If an increased stress situation in a reservoir region due to a salt weld remains undetected, unexpectedly low reservoir porosities and permeabilities would be encountered that cause wells to flow less hydrocarbons than anticipated.

1. A method for identifying a local stress anomaly in a subsurface region, which method comprises the steps of
obtaining a model of the subsurface region, which model includes a salt layer in between adjacent layers;
identifying a salt weld in the model; and
attributing a stress anomaly to an area surrounding the salt weld.

2. The method according to claim 1, wherein the step of obtaining a model includes interpreting seismic data pertaining to the subsurface region.

3. The method according to claim 1, wherein the method further comprises obtaining a quantification of the stress anomaly.

4. The method according to claim 3, wherein the method comprises geomechanic modelling, in particular by a finite elements method, of the subsurface region.

5. The method according to claim 1, wherein the method further comprises estimating a property or parameter of the subsurface region, in particular a rock property or a reservoir property, or identifying an anomaly in such a property or parameter.

6. The method according to claim 5, wherein the estimated property or parameter is selected from the group consisting of a rock permeability, a rock porosity, an acoustic or seismic velocity, and a fracture density.

7. The method according to claim 1, wherein the method further comprises obtaining an updated model of the subsurface region by refined interpretation of the seismic date using the identified stress anomaly.

8. The method according to claim 1, wherein the method further comprises selecting a trajectory for a drilling operation into a layer underneath the salt layer by taking the location of the salt weld into account.

9. The method according to claim 1, wherein the stress anomaly is a rock stress anomaly.

10. A method for identifying a local stress anomaly in a subsurface region, which method comprises the steps of
a) obtaining a model of the subsurface region, which model includes a salt layer in between adjacent layers;
b) identifying a salt weld in the model;
c) attributing a stress anomaly to an area surrounding the salt weld; and
d) considering the attributed stress anomaly in an estimation of a property or parameter of the subsurface region.

11. The method according to 9, further comprising selecting a trajectory for a drilling operation into a layer underneath the salt layer using the property or parameter estimated in step d).
